(19) United States
(12) Patent Application Publication
(10) Pub. No.: US 2005/0152147 A1
(43) Pub. Date: Jul. 14, 2005

(54) Convex light reflector

(76) Inventor: John V. Kearney, Springfield, VA (US)

Correspondence Address: LITMAN LAW OFFICES, LTD, PO BOX 15035, CRYSTAL CITY STATION, ARLINGTON, VA, 22215, US

(21) Appl. No.: 10/753,442

(22) Filed: Jan. 9, 2004

(51) Int. Cl. F21V 7/00

(52) U.S. Cl. 362/347

(57) ABSTRACT

The convex light reflector is a safety device and visual indicator designed to reflect light at angles of incidence up to and including 90°. The reflector is a hollow housing having a flat rectangular rear surface from which a round bulging portion extends forming a convex face. The convex face is adapted with a layer of reflective materials that simulates the American flag in the preferred embodiment and creates a reflective profile. An adhesive layer is bonded to the rear surface of the reflector to facilitate mounting the reflector to another object.

### BACKGROUND OF THE INVENTION

1. Field of the Invention

The present invention generally relates to safety light reflectors. More specifically, the invention is a light reflector structure made up of a housing having a convex face covered with a reflective layer that reflects light shone from any angle of incidence up to and including 90°, and simulates the American flag.

2. Description of the Related Art

Light reflectors are well known in the art as inexpensive safety devices used, for instance, to assist drivers with detecting people and objects in their path at night. Conventional light reflectors typically have a flat layer of reflective material attached to a support member. This planar arrangement is effective as a light reflector when light is directed substantially perpendicularly to a conventional reflector. However, this effectiveness diminishes greatly when the angle of incidence of the light departs significantly from a perpendicular orientation.

The range of angles of incidence that a light reflector will reflect light is an important factor in determining the effectiveness of a light reflector as a safety device. In the present context, the angle of incidence of light is the angle in degrees that a light ray striking a light reflector mounted to a flat surface makes with a line perpendicular to the light reflector. Therefore, a 90° angle of incidence is equivalent to shining light from a lateral position encompassing the profile of the light reflector. The greater the range of angles of incidence that a light reflector will reflect light back to the source, the greater the effectiveness of the light reflector as a safety device.

There exists a need for a light reflector capable of reflecting light at various angles of incidence, up to and including 90°. Various light reflectors have long been known and various inventions have been directed towards increasing the angle of incidence that a light reflector will reflect light back to the source, but none disclose the convex light reflector of the present invention.

Decals and stickers depicting the American flag are well known in the art. Two Internet prior art references, www.shop.store.yahoo.com/needdecals/refamflagdecl.html and workplacesafetyonline.com/catalog/reflective glowing America n flag 1392340.htm, show decals made from reflectorized materials that simulate the American flag and have adhesive backings. Moreover, the latter Internet reference decal also glows in the dark. These decals are typically flat and unable to reflect light from a lateral perspective. Though the decals can be applied to a 180 surface, their flexible nature precludes maintaining a convex orientation without support.

U.S. Pat. No. 4,987,848, issued Jan. 29, 1991 to D. Todd, teaches a safety flag that serves as a radar reflecting and visual identification for small boats, hunters, campers, etc. Small boats are typically made of fiberglass materials that do not reflect radar waves, thus making the vessel undetectable by radar and leaving it susceptible to collisions with other vessels. The preferred embodiment of the safety flag simulates an American flag and is made from metallic threads; yet there is no explicit teaching of the safety flag as a means to reflect light.

U.S. Pat. No. 4,285,573, issued Aug. 25, 1981 to R. Stone, and U.S. patent application Publication 2002/0113485 A1, published Aug. 22, 2002 for C. Ketter et al., both teach light reflective devices adapted for attachment to the wheel rim of a bicycle and motor vehicle, respectively. Both devices are primarily tailored for application to annular surfaces and orientations, thereby rendering the inventions ineffective for use with most mailboxes, posts, signs, etc. In addition, the Stone invention asserts that it is capable of reflecting light at angles of incidence up to and beyond 80°, yet the candle power reflectivity table provided in the specification shows marginal reflectivity at a 50° angle of incidence. Furthermore, neither invention teaches simulation of graphical or artistic representations.

U.S. Pat. No. 4,108,406, issued Aug. 22, 1978 to D. Williams, describes a rail car safety reflector that attaches to the surface of a vehicle or stationary object and produces a “flashing” visual signal with the aid of a free-swinging disk member that disrupts the light reflected from the reflective member. The reflectiveness of the Williams invention is diminished at greater angles of incidence, as it is not particularly suited for light from lateral positions. In addition, the invention does not teach simulation of graphical or artistic representations.

None of the above inventions and patents, taken either singly or in combination, is seen to describe the instant invention as claimed. Thus a convex light reflector solving the aforementioned problems is desired.

### SUMMARY OF THE INVENTION

The convex light reflector is a safety device and visual indicator designed to reflect light at angles of incidence up to and including 90°. The invention comprises a hollow housing having a flat rectangular rear surface from which a round bulging portion extends forming a convex face. The convex face has a layer of reflective material that simulates the American flag in the preferred embodiment and creates a reflective profile. An adhesive layer is bonded to the rear surface of the reflector to facilitate coupling the reflector to another object.

The present invention promotes safety and visual identification by illuminating objects from acutely lateral positions. A common failing of most light reflectors is the inability to reflect light effectively from a lateral position, because the face of a typical light reflector is flat. The convex nature of the face of the present invention remedies the aforementioned failing by providing a reflective profile when light is shone from a directly lateral position.

Accordingly, it is a principal object of the invention to provide a convex light reflector capable of reflecting light at angles of incidence up to and including 90°.

It is another object of the invention to provide a light reflector capable of simulating various objects and designs, particularly the American flag.

It is a further object-of the invention to provide a light reflector that can be coupled to a multitude of objects such as mailboxes, signs, posts, etc.

Still another object of the invention is to provide a cost-effective safety device capable of illuminating a mailbox, post, sign, etc.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1A is a perspective view of a convex light reflector according to the present invention.

FIG. 1B is an exploded fragmentary view of the reflective layer covering the convex face.

FIG. 2 is a top view of the convex light.

FIG. 3 is a rear perspective view of the convex light reflector according to the present invention showing a release liner for the adhesive layer on the rear of the convex light reflector.

Similar reference characters denote corresponding features consistently throughout the attached drawings.

### DETAILED DESCRIPTION OF THE PREFERRED EMBODIMENTS

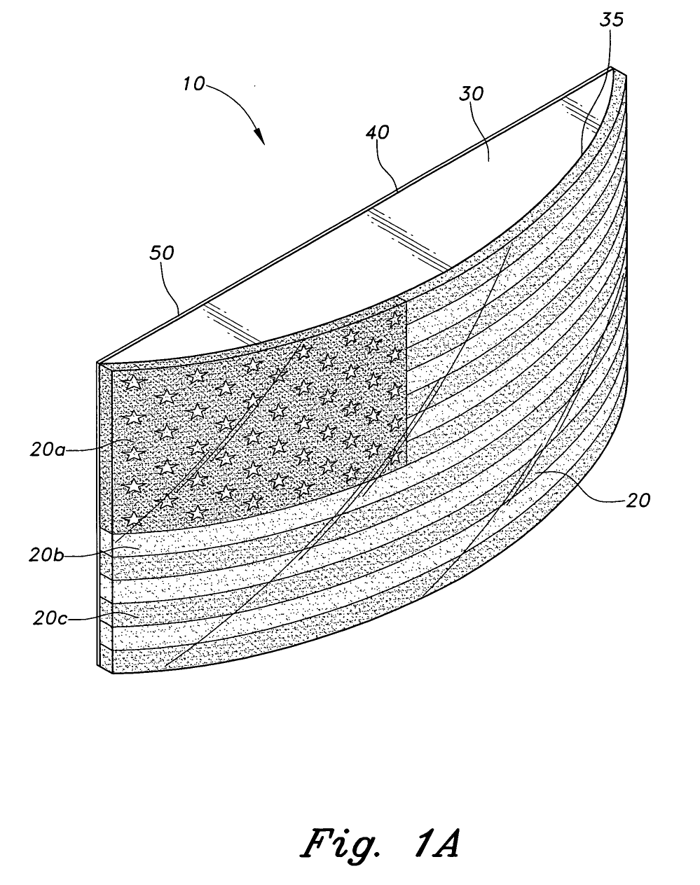

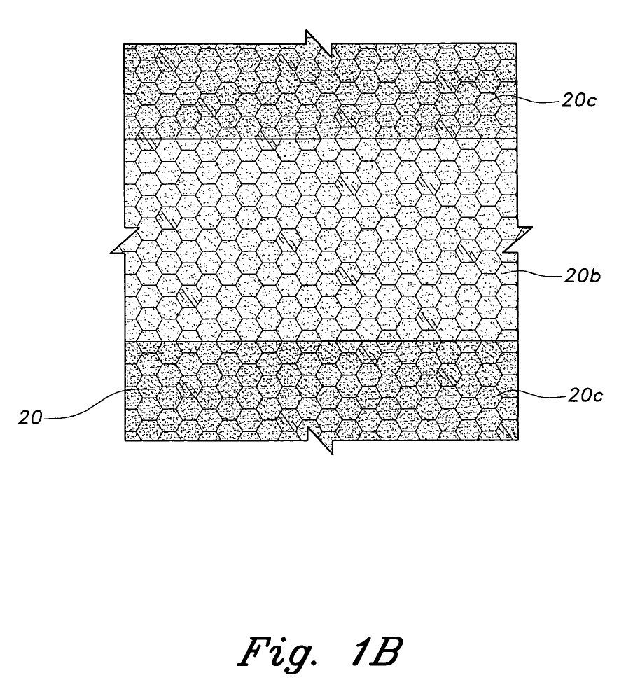

The present invention is a convex light reflector designated generally as 10 in the drawings. Referring to FIG. 1, the convex light reflector 10 is a safety device and visual indicator designed to reflect light at angles of incidence up to and including 90°.

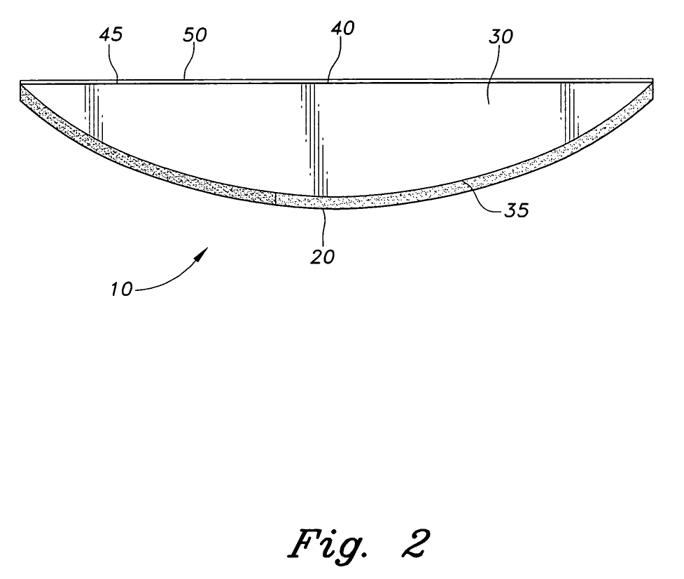

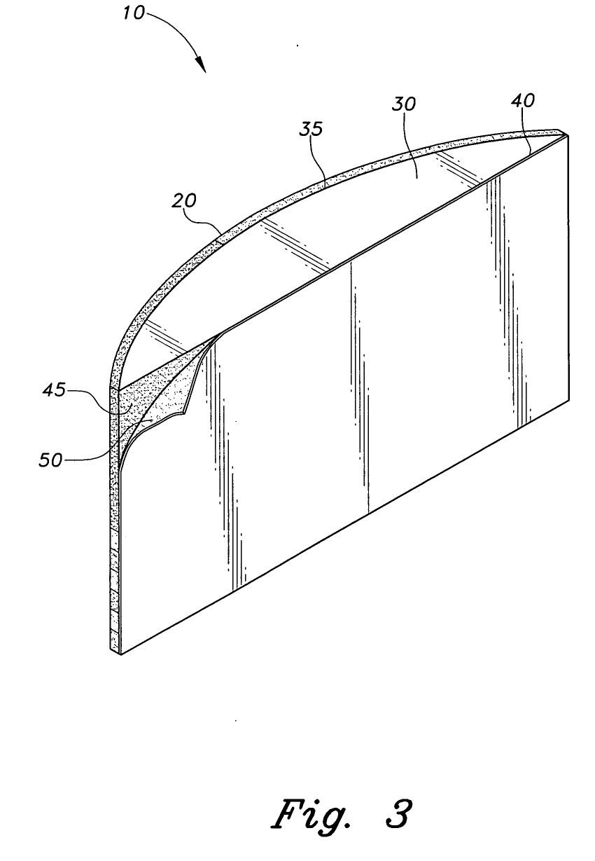

Referring to the drawings, the convex light reflector 10 comprises a hollow housing 30 having a generally curved configuration. The hollow housing 30 has a flat rectangular rear surface 40 (FIGS. 2 and 3) from which a round bulging portion extends forming a convex face 35. The convex nature of the face 35 affords the invention a bulging side profile that is a departure from conventional light reflectors and is capable of reflecting light from acutely lateral positions. The hollow housing 30 can be constructed from plastic or any rigid material that accepts adhesively bonded layers. The convex light reflector 10 can be ideally manufactured with a rear surface 40 that is 3 inches×5 inches in size and a convex face 35 that is adapted accordingly. However, the convex light reflector 10 can be made in a wide range of sizes.

Referring to FIGS. 1A and 1B, the convex face 35 of the convex light reflector 10 is covered with a contoured layer 20 of light-reflective material. The light-reflective layer 20 simulates the stars 20a and alternating white stripes 20b and red stripes 20c of the American flag in the preferred embodiment. This layer 20 is adaptable to simulate a multitude of objects, designs, depictions, etc. and accommodate varying sizes of the convex face 35. FIG. 1B best shows the layer 20 of light reflective material, which is faceted and well known in the art. The layer 20 is adhesively bonded to the convex face 35.

In alternative embodiments, a layer of luminous material or a layer of light reflective paint can be used to cover the convex face 35. Moreover, an active light source can be placed inside the hollow housing 30 and serve to illuminate the invention without deviating from the scope of the invention as a safety device and visual indicator.

Referring to FIG. 1A, when light is directed from a 90° angle of incidence, the bulge of the convex face 35 in conjunction with the reflective layer 20 act as a reflective profile capable of reflecting light from that acutely lateral position. This wide range of angles of incidence serves to catapult the effectiveness of the convex light reflector 10 as a light reflecting means which enhances the performance of the convex light reflector 10 as a safety device and visual indicator.

Referring to FIGS. 2 and 3, a layer 45 of adhesive material is provided, bonded to the rear surface 40 of the convex light reflector 10 to facilitate attaching the convex light reflector 10 to the surface of another object. The exterior side of the adhesive layer 45 is covered with a release liner 50 that is peeled away in order to expose the tacky surface of the exterior side, prior to attaching the convex light reflector 10 to the surface of another object. The convex light reflector 10 is aligned with the exposed surface of the targeted object and the tacky surface of the adhesive layer 45 is firmly engaged against the object surface to secure the invention.

In the alternative, the adhesive layer 45 can be bonded to the top and/or bottom of the hollow housing 30 of the convex light reflector 10 depending on the orientation needed. Also, the convex light reflector 10 can be attached to the surface of an object using hook and loop fasteners (not shown) for an easily detachable connection or screwedly joined for a more permanent connection. Furthermore, the bottom and top of the hollow housing 30 can be adapted to facilitate mounting the convex light reflector 10 atop and beneath, respectively, the ends of poles, posts, etc.

It is to be understood that the present invention is not limited to the embodiments described above, but encompasses any and all embodiments within the scope of the following claims.

1. A convex light reflector for use as a safety device and visual indicator, comprising:
a hollow housing having a generally curved configuration with a flat rectangular rear surface from which a round bulging portion extends forming a convex face;
a layer of light reflective material bonded to and covering said convex face;
a layer of adhesive material having an interior side and an exterior side where the interior side bonds to and covers said rear surface;
a release liner covering said exterior side.

2. The convex light reflector according to claim 1 wherein said layer of reflective material is faceted and simulates an American flag.

3. The convex light reflector according to claim 1 wherein said layer of reflective material is light reflective paint.

4. A convex light reflector for use as a safety device and visual indicator, comprising:
a hollow housing having a generally curved configuration with a flat rectangular rear surface from which a round bulging portion extends forming a convex face;
a layer of light reflective material bonding to and covering said convex face;
a layer of adhesive material having an interior side and an exterior side where the interior side bonds to and covers the top of said housing;
a release liner covering said exterior side.

5. The convex light reflector according to claim 4 wherein said layer of reflective material is faceted and simulates an American flag.

6. The convex light reflector according to claim 4 wherein said layer of reflective material is light reflective paint.

7. A convex light reflector for use as a safety device and visual indicator, comprising:
a hollow housing having a generally curved configuration with a flat rectangular rear surface from which a round bulging portion extends forming a convex face;
a layer of light reflective material bonding to and covering said convex face;
a layer of adhesive material having an interior side and an exterior side where the interior side bonds to and covers the bottom of said housing;
a release liner covering said exterior side.

8. The convex light reflector according to claim 7 wherein said layer of reflective material is faceted and simulates an American flag.

9. The convex light reflector according to claim 7 wherein said layer of reflective material is light reflective paint.
